(19) United States
(12) Patent Application Publication
(10) Pub. No.: US 2024/0138559 A1
(43) Pub. Date: May 2, 2024

(54) ELEVATED STORAGE

(71) Applicant: A&C FUTURE, INC., Newport Beach, CA (US)

(72) Inventors: Xunmin Jiang, Irvine, CA (US); Jiuqi Wang, Santa Ana, CA (US); Zhuangboyu Zhou, Santa Ana, CA (US); Sichen Li, Santa Ana, CA (US); Ju Gao, Newport Beach, CA (US); Han Qin, Newport Beach, CA (US); Jiayang Qin, Newport Beach, CA (US)

(21) Appl. No.: 18/051,086

(22) Filed: Oct. 31, 2022

(51) Int. Cl. A47B 5/00; A47B 46/00

(52) U.S. Cl. CPC A47B 5/00; A47B 46/00

(57) ABSTRACT

A storage mechanism for houses and expandable houses allows items to be stored in a space close to the ceiling so the storage space will not reduce the available floor space in the house. The storage will only reduce the height of the ceiling by a small amount, which does not affect most people. When activated, the system can automatically move the stored item to the room on the side and make them accessible to the user. The design aims to allow the users to store many items on top of their head to save spaces. It essentially eliminates the need of an additional storage room in smaller houses. It also allows multifunctional room when the storage system have some furniture like a TV and a mattress installed in it. It can help smoothly transform a living room to a bedroom and vice versa.

### BACKGROUND OF THE INVENTION

### 1. Field of the Invention

Embodiments of the invention relate generally to storage solutions. More particularly, embodiments of the invention relate to an elevated storage system that can store items close to a ceiling of a home without decreasing floor space.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Storage space is often sacrificed for living space in homes, especially in smaller homes. Users may add storage spaces, but they typically require floor space for their deployment. Some storage solutions, such as shelves or platforms, can be used, but are typically difficult to install and reduce the overall aesthetics of the room.

In view of the foregoing, there is a need for a storage solution that may not reduce floor space while maintaining the overall aesthetics of the living space.

### SUMMARY OF THE INVENTION

Embodiments of the present invention aim to solve the aforementioned problems in conventional storage solutions. Aspects of the present invention may be more useful in smaller houses and expandable houses where the living spaces are limited, and the owner cannot afford to include a room that is only for storage. The items can be stored in the system include, but not limited to, a bed mattress, a drawer like container, a TV, and the like. The storage system also allows easier access to the stored item when compared to a regular storage room. When activated, the system can automatically move the stored item to the room on the side and make them accessible to the user.

Embodiments of the present invention provide an elevated storage structure comprising a track for moving a movable member horizontally out of a storage configuration located near a ceiling of a structure and into a deployed configuration; and a plurality of cables attached to and extendable from the movable member, the plurality of cables operable to move a stored item vertically from the movable member when the movable member is in the deployed configuration.

Embodiments of the present invention provide a elevated storage structure comprising a storage area disposed adjacent a ceiling of a structure; an opening of the storage area opening into a first space in or adjacent the structure; first and second tracks, located along opposite sides of the storage area, operable to move respective first and second movable members horizontally out of the opening of the storage area, from a storage configuration into a deployed configuration; a movable member driving mechanism operable to move the first and second movable members along the first and second tracks; and a plurality of cables attached to and extendable from the movable member, the plurality of cables operable, via a cable driving mechanism, to move a stored item vertically from the movable member when the movable member is in the deployed configuration.

Embodiments of the present invention provide a elevated storage structure comprising a storage area disposed adjacent a ceiling of a structure; an opening of the storage area opening into a first space in or adjacent the structure; first and second tracks, located along opposite sides of the storage area, operable to move respective first and second movable members horizontally out of the opening of the storage area, from a storage configuration into a deployed configuration; a movable member driving mechanism operable to move the first and second movable members along the first and second tracks; a first pivot axis located at a distal end of each of the first and second movable members, the first pivot axis providing a pivot between a television connector, attached to a television, and the first and second movable members; and a second pivot axis located at proximal ends of each of the first and second movable members, the second pivot axis providing a second pivot between the first and second tracks and the first and second movable members.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIGS. 1A through 1D illustrate perspective, top, side and end views of a home or home portion with a storage solution disposed therein, the storage solution being empty, according to an exemplary embodiment of the present invention;

FIGS. 2A through 2D illustrate perspective, top, side and end views of a home or home portion with a storage solution disposed therein, the storage solution being filled and in a storage configuration, according to an exemplary embodiment of the present invention;

FIGS. 3A through 3D illustrate perspective, top, side and end views of a home or home portion with a storage solution disposed therein, the storage solution being filled and in a deployed configuration, according to an exemplary embodiment of the present invention;

FIG. 4 illustrates a back perspective view of a home or home portion with a storage solution disposed therein, the storage solution including a television storage region with the television in a deployed configuration;

FIG. 5 illustrates a front perspective view of a home or home portion with a storage solution disposed therein, with arrows illustrating deployment of a mattress and a storage container, according to an exemplary embodiment of the present invention;

FIGS. 6A through 6D illustrate perspective, top, side and end views of a powered sliding rail for moving stored objects of the storage solution of FIG. 1A, in a storage configuration, according to an exemplary embodiment of the present invention;

FIGS. 7A through 7D illustrate perspective, top, side and end views of the powered sliding rail of FIGS. 6A through 6D, in a deployed configuration, according to an exemplary embodiment of the present invention;

FIGS. 8A through 8D illustrate exploded perspective, top, side and end views of the powered sliding rail of FIGS. 6A through 6D, according to an exemplary embodiment of the present invention;

FIGS. 9A through 9D illustrate perspective, top, side and end views of the deployment line coil storage device of the powered sliding rail of FIGS. 6A through 6D, according to an exemplary embodiment of the present invention;

FIGS. 10A through 10D illustrate exploded perspective, top, side and end views of the deployment line coil storage device of FIGS. 9A through 9D, according to an exemplary embodiment of the present invention;

FIGS. 11A through 11D illustrate perspective, top, side and end views of a rotatable powered sliding rail for moving stored objects of the storage solution of FIG. 1A, in a storage configuration, according to an exemplary embodiment of the present invention;

FIGS. 12A through 12D illustrate exploded perspective, top, side and end views of the rotatable powered sliding rail of FIGS. 11A through 11D, according to an exemplary embodiment of the present invention;

FIG. 13 illustrates an exploded bottom perspective view of the rotatable powered sliding rail of FIGS. 11A through 11D;

FIGS. 14A through 14D illustrate perspective, top, side and end views of the rotatable powered sliding rail of FIGS. 11A through 11D, in a deployed configuration, according to an exemplary embodiment of the present invention; and

FIGS. 15A through 15D illustrate exploded perspective, top, side and end views of the rotatable powered sliding rail of FIGS. 11A through 11D, in a deployed configuration, according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a storage mechanism for houses and expandable houses that allows items to be stored in a space close to the ceiling so the storage space will not reduce the available floor space in the house. The storage will only reduce the height of the ceiling by a small amount, which does not affect most people. Aspects of the present invention may be more useful in smaller houses and expandable houses where the living spaces are limited, and the owner cannot afford to include a room that is only for storage. The items can be stored in the system include, but not limited to, a bed mattress, a drawer like container, a TV, and the like. The storage system also allows easier access to the stored item when compared to a regular storage room. When activated, the system can automatically move the stored item to the room on the side and make them accessible to the user.

The design aims to allow the users to store many items on top of their head to save spaces. It essentially eliminates the need of an additional storage room in smaller houses. It also allows for a multifunctional room when the storage system has some furniture like a mattress and a TV installed therein. The system can help smoothly transform a living room to a bedroom and vice versa.

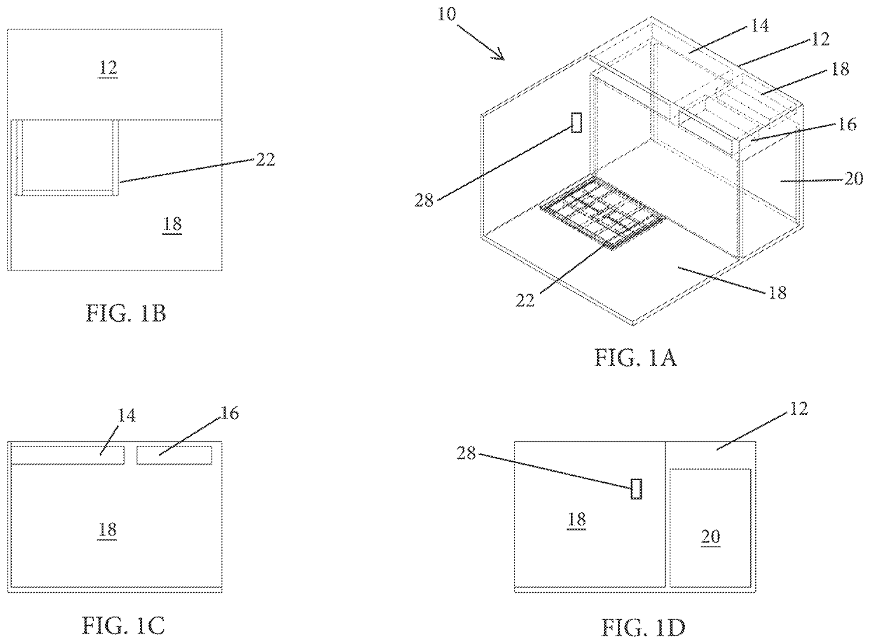

Referring to FIGS. 1A through 5, a home 10, or a portion thereof, can include, for example, a first room 18 and a second room 20. A ceiling height in the second room 20 may be reduced to accommodate a storage system 12. This ceiling height reduction may be from about 10 inches to about 20 inches, for example. While the Figures show two rooms 18, 20, with the storage system 12 occupying the ceiling level of an entirety of the second room 20, the storage system 12 may be disposed in any area in the home 10 and may occupy all or a portion of any room, closet, or the like.

Multiple storage chambers may be disposed in the storage system 12. For example, the storage system 12 can include a large storage area 14, a small storage area 16 and a television storage chamber 18. Of course, the number and size of the storage chambers can vary depending on the specific application. The room 18 may include one or more indicators 22, such as a rug, that indicate where an item from one of the storage areas, such as the large storage area 14 may be disposed, once lowered, as discussed in greater detail below. A remote control 28 may be disposed on the wall of the room 18 to operate the storage system 12, as discussed in greater detail below.

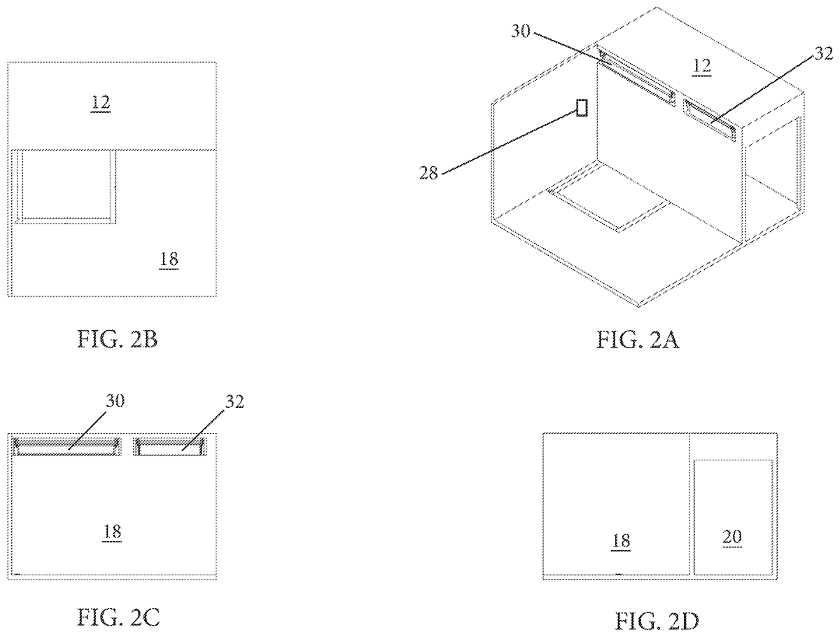

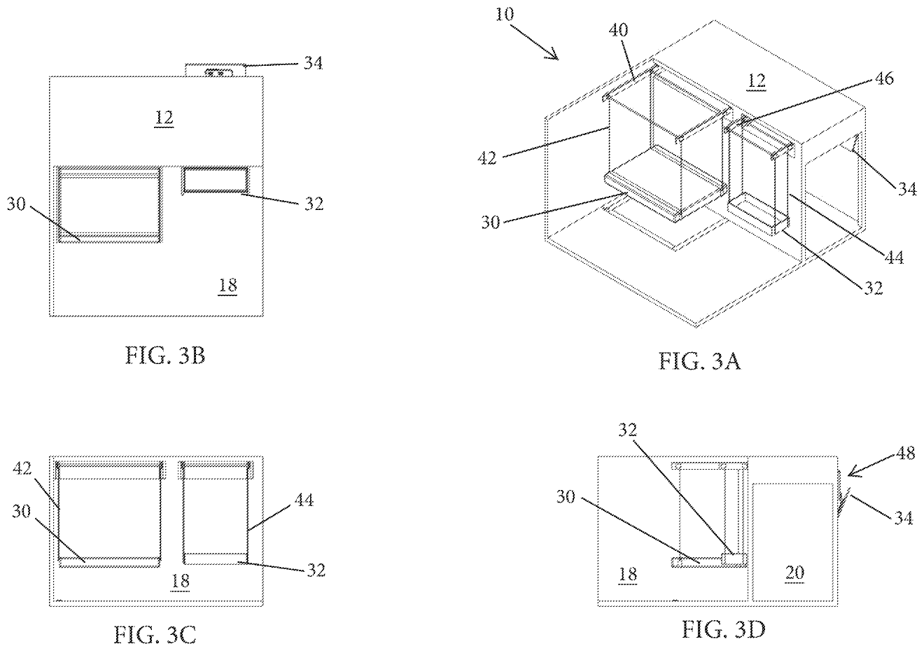

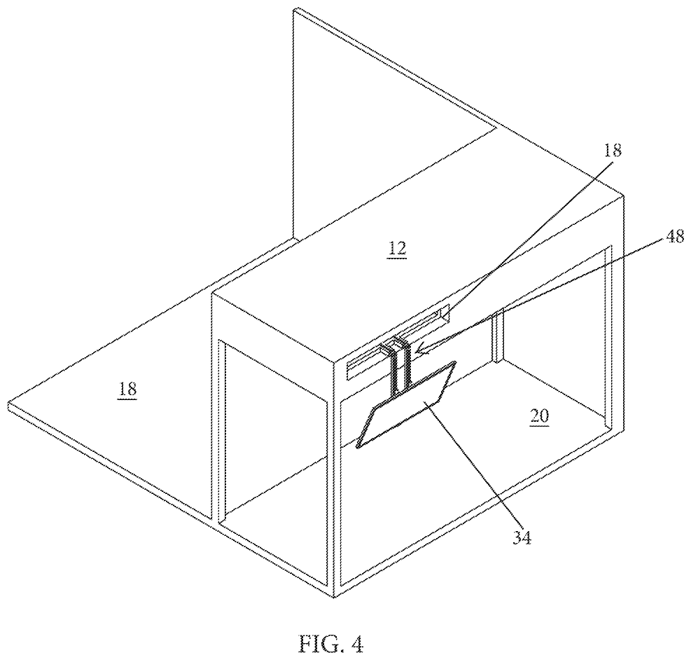

While FIGS. 1A through 1D show the storage areas 14, 16, 18 empty, FIGS. 2A through 2D show these storage areas 14, 16, 18 having items therein. For example, a mattress 30 may be disposed in the large storage area 14, a storage basket 32 may be stored in the small storage area 16 and a television 34 (see FIGS. 3A through 4) may be stored in the storage area 18.

FIGS. 3A through 4 illustrate the storage system 12 with the items stored therein in a deployed configuration. The mattress 30 may be hung from movable rails 40 via hanging cords 42. Similarly, the storage basket 32 may be hung from movable rails 466 with cords 44. In some embodiments, the items may be lowered to a maximum distance above the floor of the room, or, in other embodiments, the items may be lowered all the way to the floor. For example, to convert a room into a bedroom, the mattress 30 may be deployed and hung a distance off the floor, as shown in FIG. 3A, for example. In some embodiments, additional straps, connectors or hooks (not shown) may be used to retain the mattress 30 in the deployed configuration to, for example, prevent swinging of the mattress 30 during use thereof.

As can best be seen in FIG. 4, a television 34 may be hung by a bracket 48 out of the storage area 18. As discussed in greater detail below, the bracket 48 may be extended out to the deployed position to permit automatic deployment of the television 34.

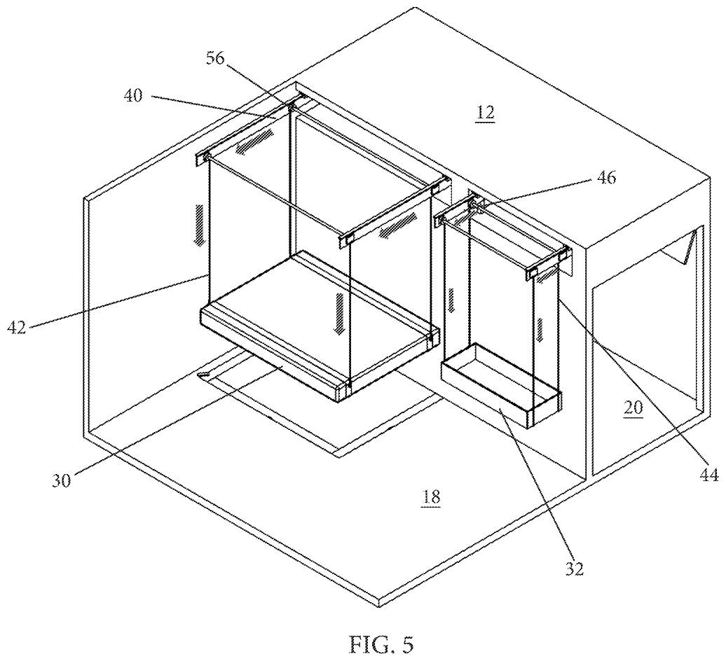

FIG. 5 shows the generally movement as the storage system 12 moved from the storage configuration to the deployed configuration. The movable rails 40, 46 may slide out from the storage regions 14, 16. Once fully extended, the cords 42, 44 are extended from spools 56 (as described below) to permit the stored items (such as the mattress 30 and the storage basket 32) to lower.

It should be understood that the mattress 30 and the storage basket 32 are exemplary items in the storage areas 14, 16. Other items may be stored as well. Further, the stored items may be attached to the cords 42, 44 in various manners, such as be straps, screws, bolts, adhesive, or the like. Further, the cords 42, 44 may be various material suitable to support the weight of the items, including nylon cords, rope, cable, straps, or the like.

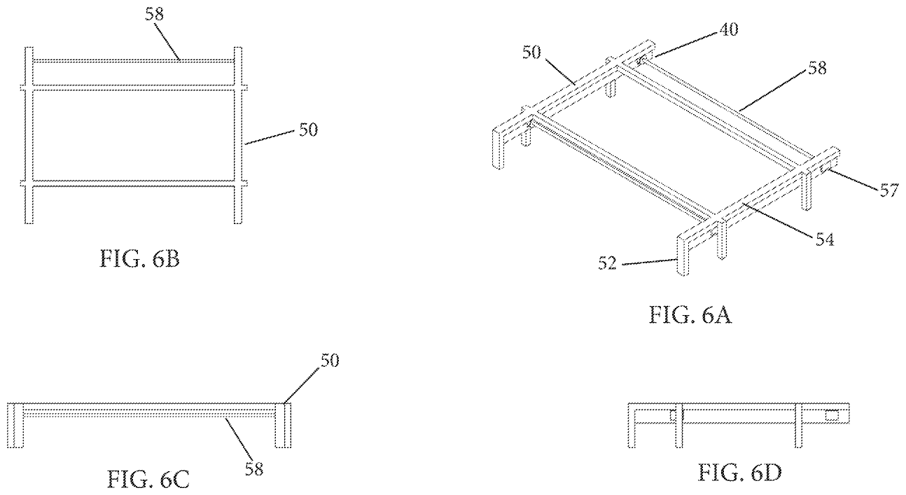

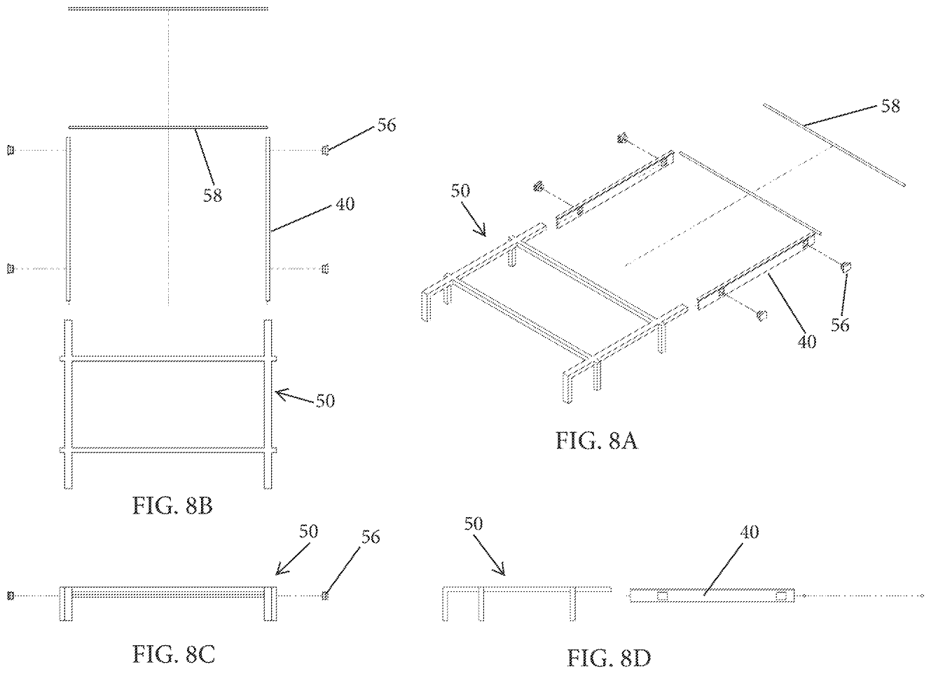

Referring now to FIGS. 6A through 8D, the sliding rail system 50 is described in greater detail. The sliding rail system 50 may fit, for example, in the large storage area 14 and the small storage area 16, where the width and depth may vary depending on the size of the specific storage area. The sliding rail system 50 can include fixed rails 54 and movable rails 40 movable relative to the fixed rails 54. The fixed rails 54 may be supported by a plurality of legs 52. Typically, the legs 52 will have a length sufficient to dispose the fixed rail 54 adjacent the ceiling or uppermost part of the room in which the storage system 12 is installed. In other words, the legs 52 will support the fixed rail 54 adjacent the top of the storage areas 14, 16.

The movable rail 40 may slide from opposite fixed rails 54 disposed on opposite sides of the storage areas 14, 16. The movable rails 40 may be driven by various driving means 60, such as a linear actuator, a screw member, a belt or chain drive, or the like. The driving means 60 can move the movable rails 40 between the storage configuration and the deployed configuration. The driving means 60 may drive one side or both sides, thus driving one movable rail 40 or both movable rails 40. The movable rails 40 may be interconnected by two or more cross members 58. The cross members 58 may be mounted to the spools 56, as shown, or in different positions along the length of the movable rails 40.

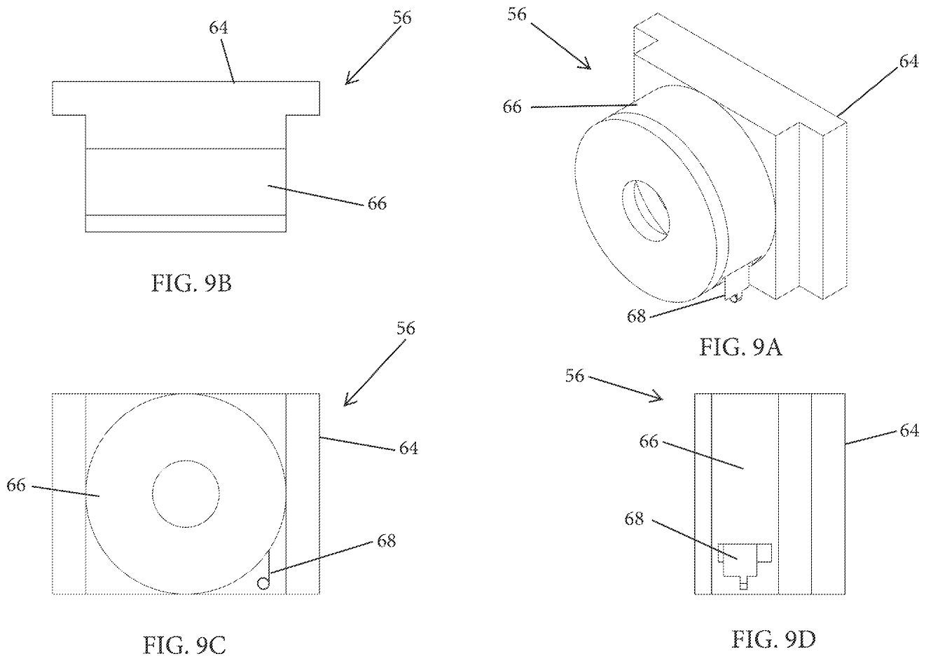

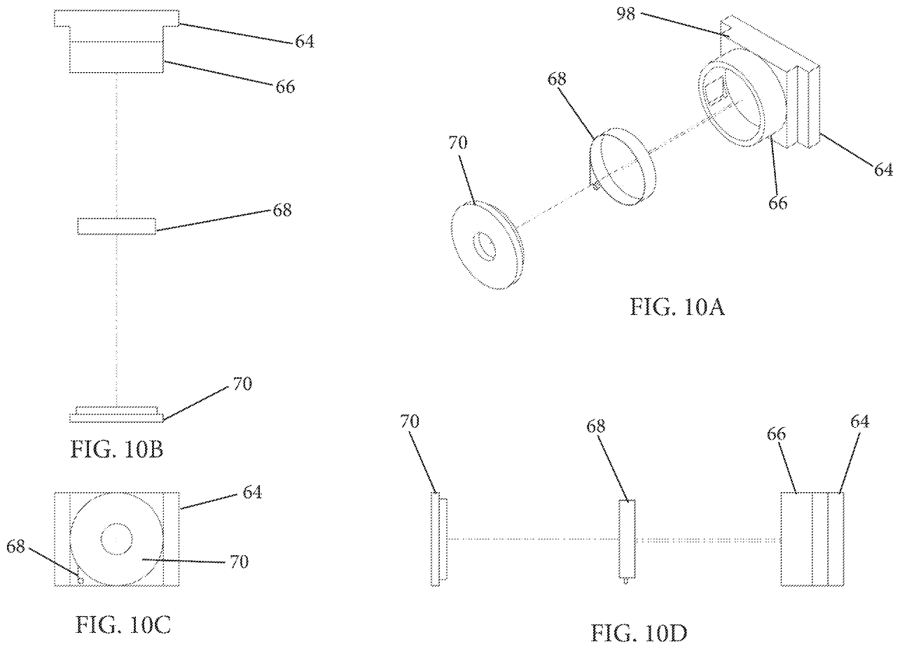

Referring now to FIGS. 9A through 10D, the spool 56 is described in greater detail. The spool 56 can include a mounting side 64, configured to be mounted to the movable rails 40, described above. A spool cover 66 may extend inward from the mounting side 64 of the spool 56. A cord 68 (similar to the cord 42, 44, discussed above, where the cord 68 may be used as the cord 42, 44 in the instances described above) may extend from the spool 56 to attach to the stored item. A spool cover 70 may be removable attached to the end of the spool 56, retaining the cord 68 inside the spool cover 66.

The cord 68 may be driven out from the spool 56 or back into the spool 56. In some embodiments, the remote control 28 may have controls for each storage area to operate each set of spools 56 therein. In some embodiments, the mounting base 64 can include a cord moving device 98, operable to move the cord 68 into and out of the spool 56. In some embodiments, the cord 68 may wrap along an interior portion 71 of the spool cover 70 and a driving means 57 (see FIG. 6A, for example) may drive the spool cover 70. In some embodiments, the spool covers 70 may be interconnected by the cross members 58, where the driving means 57 may drive the cross members 58 to turn each of the spool covers 70 attached thereto. The driving means 57 may be a motor, for example, that moves along with the movement of the movable rails 40.

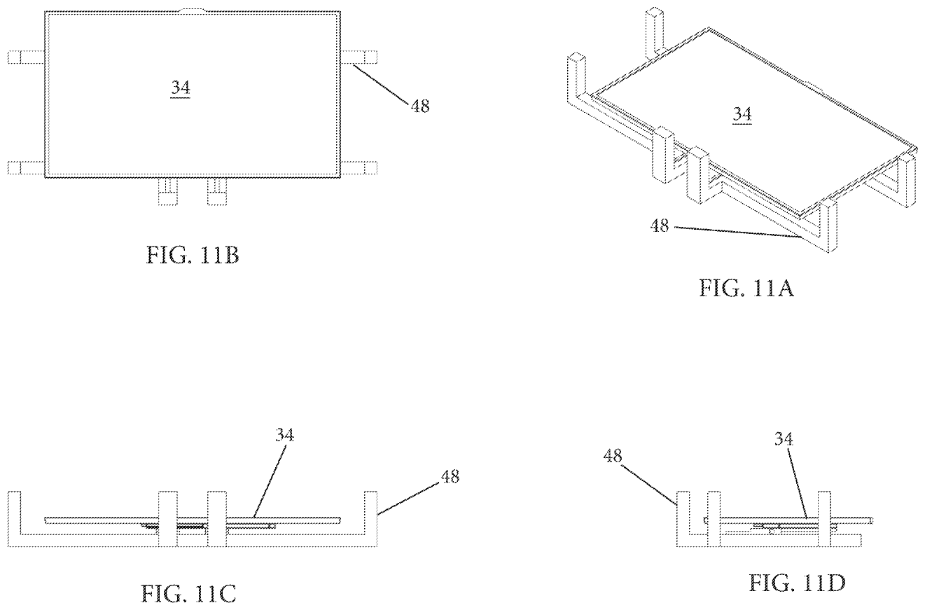

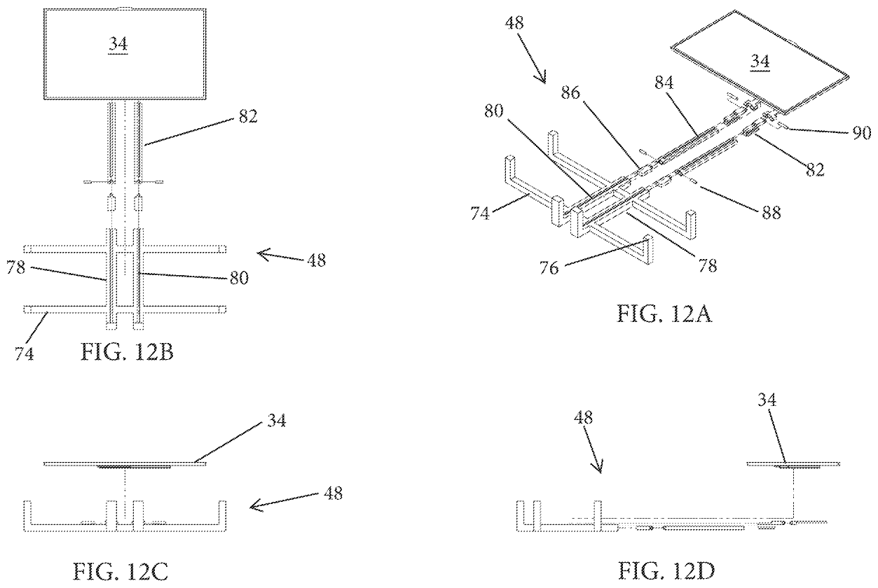

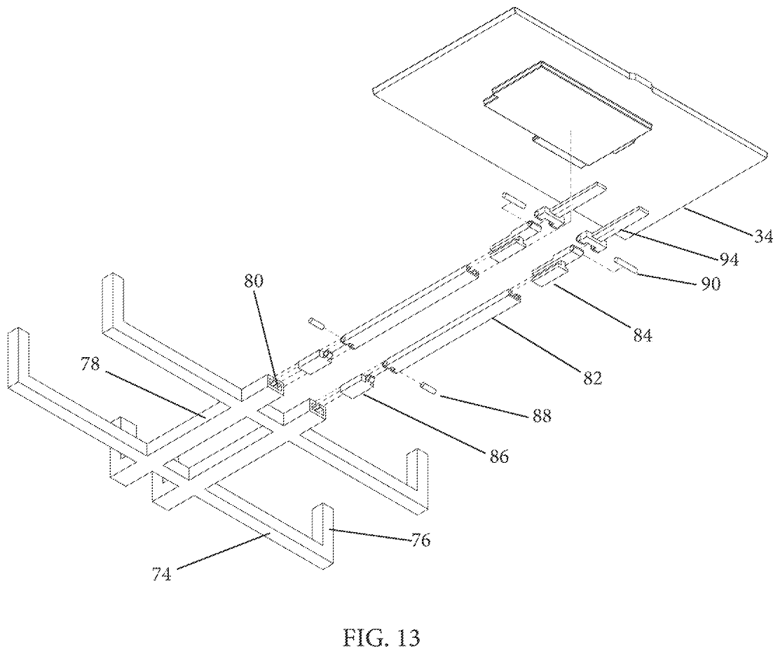

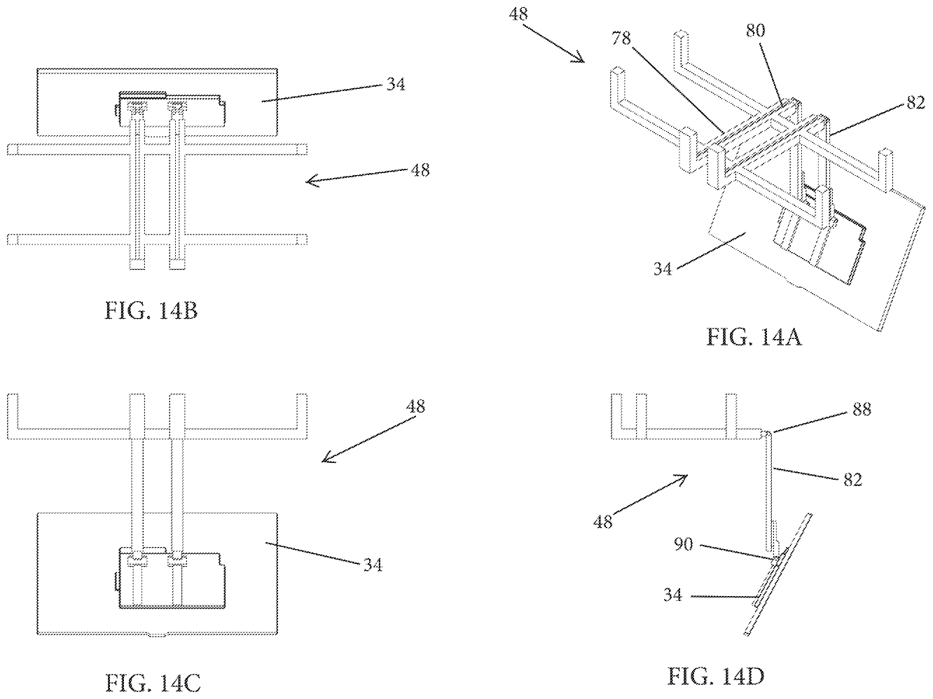

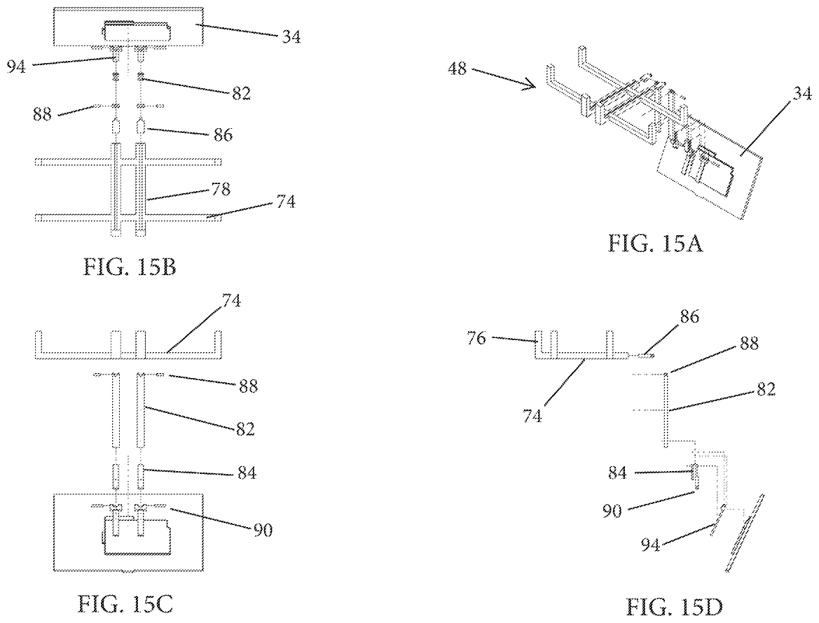

Referring now to FIGS. 11B through 15D, a television mount 48 may hold a television 34 therein in the stored configuration and may release the television 34 into a use position when in the deployed configuration.

The television mount 48 may include side rails 74 that extend from side to side, extending outward from slide rails 78, the slide rails 78 having a channel 80 formed therein. Legs 76 can extend upward in this case, where the side rails 74 and the slide rails 78 are disposed adjacent a bottom surface of the storage area 18 and the legs 76 extend upward toward the top of the storage area 18. The side rails 78 extend generally perpendicular to the movement of the television 34, as discussed below, while the slide rails 78 extend generally parallel to the movement of the television 34.

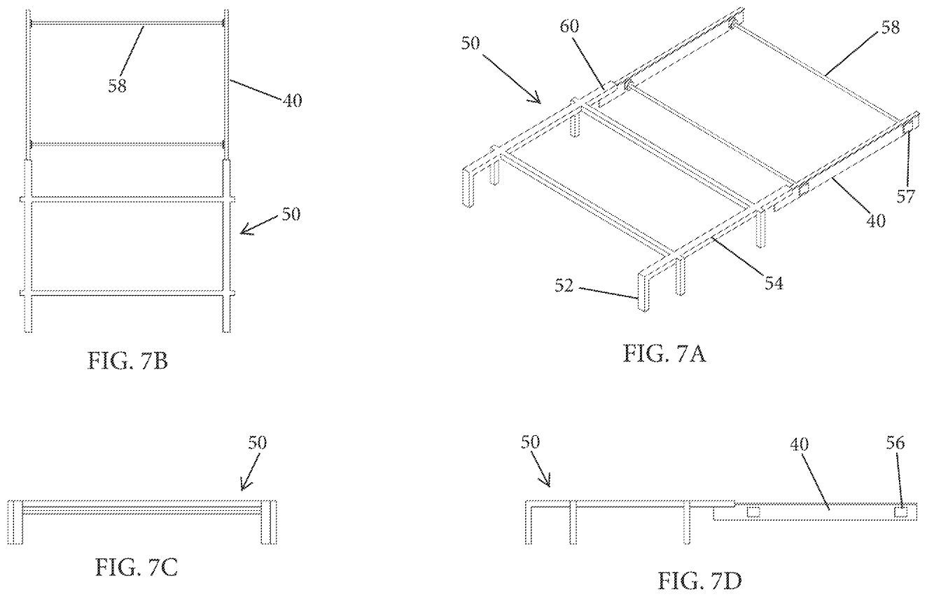

Sliding rails 82 may be disposed inside the slide rails 78 and may be configured to slide outward from the slide rails 78 to move the television between the storage position and the use position. The sliding rails 82 may slide by a driving means similar to that discussed above with respect to the driving means 60 for moving the movable rails 40 from the fixed rails 54 (see FIG. 7A).

A first pivot connector 84 may attach to television connectors 94 that are configured to attach to the television 34. The first pivot connector 84 and the television connector 94 can attach with a pivot pin 90, which forms the first pivot axis. The first pivot connector 84 may attach to a distal end (relative to the slide rail 78 when in the deployed configuration) of the sliding rails 82.

A second pivot connector 86 may attach to a proximal end of the sliding rails 82. The second pivot connector 86 forms a pivot axis via a pivot pin 88 that connects the second pivot connector 86 with the sliding rails 82. In some embodiments, the second pivot connector 86 may provide an extension limit so that the sliding rail 82 does not overly extend out of the slide rails 78.

During deployment, the sliding rails 82 can slide out of the slide rails 78. Once the sliding rails 82 extend beyond the first pivot connector 84, the television 34 can pivot about the pivot axis provided by pivot pins 90 so that the screen is directed away from the opening of the storage area 18. The sliding rails 82 continue to extend until the pivot axis provided by the pivot pins 88 is extended out of the slide rails 78, causing the sliding rails 82 to pivot downward, thus placing the television 34 in the deployed position, as best seen in FIG. 4. The pivot pins 88, 90 may be designed to cause the television 34 to pivot into a user desired position when deployed. During retraction of the sliding rails 82 the reverse can occur, causing the television 34 to move back into the storage configuration inside of the storage area 18.

While three storage areas are provided in the storage system 12 discussed above, there can be any number of storage areas, depending on the usage and needs of the end user.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An elevated storage structure comprising:
a track for moving a movable member horizontally out of a storage configuration located near a ceiling of a structure and into a deployed configuration; and
a plurality of cables attached to and extendable from the movable member, the plurality of cables operable to move a stored item vertically from the movable member when the movable member is in the deployed configuration.

2. The elevated storage structure of claim 1, further comprising a lift mechanism to move the plurality of cables to move the stored item downward into a use position, and upward to a deployed configuration, permitting the stored item to be further moved, with the movable rails, back into the storage configuration.

3. The elevated storage structure of claim 1, wherein the track is disposed inside a storage area, the track positioned adjacent an upper surface of the storage area, the storage area positioned at an uppermost location in a room.

4. The elevated storage structure of claim 3, wherein the storage area is enclosed at least on the top, bottom, back and sides thereof.

5. The elevated storage structure of claim 1, wherein the track includes first and second tracks disposed on opposite sides of a storage area.

6. The elevated storage structure of claim 5, wherein the track is supported by legs extending from a bottom surface of the storage area to position the track adjacent an upper surface of the storage area.

7. The elevated storage structure of claim 1, further comprising driving means operable to move the movable member from completely inside a storage area to the deployed configuration, extending outside of the storage area.

8. The elevated storage structure of claim 7, wherein the driving means is controlled by a remote control.

9. The elevated storage structure of claim 1, further comprising a plurality of spools, one of the plurality of spools receiving respective ones of the plurality of cables.

10. The elevated storage structure of claim 9, further comprising a driving mechanism for driving the plurality of spools to release the cables or retract the cables therein.

11. The elevated storage structure of claim 10, further comprising a remote control operating the driving mechanism.

12. The elevated storage structure of claim 1, further comprising a plurality of storage areas each separately receiving the track therein, each of the plurality of storage areas including the movable member extending outward, along the track, from each of the plurality of storage areas.

13. The elevated storage structure of claim 12, wherein at least one of the plurality of storage areas open into a first space and at least one of the plurality of storage areas open into a second space.

14. The elevated storage structure of claim 1, wherein:
the stored item is a television, wherein the television is movable between the storage configuration and the deployed configuration;
the plurality of cables form the movable member and are rigidly disposed within the track and extend from the track;
a pivot member is located on each end of the movable member; and
the television automatically pivots into a user position during movement of the movable member into the deployed configuration.

15. An elevated storage structure comprising:
a storage area disposed adjacent a ceiling of a structure;
an opening of the storage area opening into a first space in or adjacent the structure;
first and second tracks, located along opposite sides of the storage area, operable to move respective first and second movable members horizontally out of the opening of the storage area, from a storage configuration into a deployed configuration;
a movable member driving mechanism operable to move the first and second movable members along the first and second tracks; and
a plurality of cables attached to and extendable from the movable member, the plurality of cables operable, via a cable driving mechanism, to move a stored item vertically from the movable member when the movable member is in the deployed configuration.

16. The elevated storage structure of claim 15, further comprising a remote control for selectively operating the movable member driving mechanism and the cable driving mechanism.

17. The elevated storage structure of claim 15, further comprising a plurality of spools, one of the plurality of spools receiving respective ones of the plurality of cables.

18. The elevated storage structure of claim 15, wherein the storage area includes a plurality of storage areas, each independently operable to move stored item into and out of the respective ones of the plurality of storage areas.

19. The elevated storage structure of claim 15, wherein the first and second tracks are supported by legs extending from a bottom surface of the storage area to position the first and second tracks adjacent an upper surface of the storage area.

20. An elevated storage structure comprising:
a storage area disposed adjacent a ceiling of a structure;
an opening of the storage area opening into a first space in or adjacent the structure;
first and second tracks, located along opposite sides of the storage area, operable to move respective first and second movable members horizontally out of the opening of the storage area, from a storage configuration into a deployed configuration;
a movable member driving mechanism operable to move the first and second movable members along the first and second tracks;
a first pivot axis located at a distal end of each of the first and second movable members, the first pivot axis providing a pivot between a television connector, attached to a television, and the first and second movable members; and
a second pivot axis located at proximal ends of each of the first and second movable members, the second pivot axis providing a second pivot between the first and second tracks and the first and second movable members.
